(19) United States
(12) Patent Application Publication
(10) Pub. No.: US 2019/0005926 A1
(43) Pub. Date: Jan. 3, 2019

(54) LIGATURE FOR ATTACHING A SINGLE VIBRATING REED TO A MOUTHPIECE OF A MUSICAL INSTRUMENT

(71) Applicant: Jean-Jacques MURE, Saint-maurice-de-lignon (FR)

(72) Inventor: Jean-Jacques MURE, Saint-maurice-de-lignon (FR)

(21) Appl. No.: 15/752,356

(22) PCT Filed: Aug. 18, 2016
(86) PCT No.: PCT/FR2016/052088

§ 371 Date: Feb. 13, 2018

(30) Foreign Application Priority Data
Aug. 19, 2015 (FR) 1557812

(51) Int. Cl. G10D 9/02

(52) U.S. Cl. CPC G10D 9/023

(57) ABSTRACT

The invention concerns a ligature (1) for attaching a single flapping reed (3) to a mouthpiece (2) of a musical instrument, comprising a main body secured to said mouthpiece and:
a holding member of the reed (3), movably mounted between a stress position in which it exerts on the reed (3) an immobilization stress of the reed (3) and at least one release position in which it releases said stress in order to authorize a displacement of the reed (3),
a control lever pivotally mounted between a rest position in which it cooperates with the holding member so that said holding member occupies the stress position thereof and at least one actuated position in which it stresses the holding member in the release position thereof,
and an elastic return member.
Wind musical instruments.

### TECHNICAL FIELD

The present invention generally concerns the field of musical wind instruments with a single flapping reed, and relates more particularly to the technical field of the fastening devices of a single flapping reed to the mouthpiece of a musical instrument, for example a clarinet or a saxophone.

The present invention concerns more particularly a ligature for attaching a single flapping reed to a mouthpiece of a musical instrument, said ligature comprising a main body intended to be secured to said mouthpiece.

The present invention also concerns an attachment method of a single flapping reed to a mouthpiece of a musical instrument by means of a ligature, said ligature comprising a main body intended to be secured to said mouthpiece.

### PRIOR ART

The sound of musical wind instruments with a single flapping reed, such as for example the clarinet or the saxophone, is produced by the vibration of a reed on a mouthpiece under the effect of the breath of the musician taking the mouthpiece between his lips. Made from a part of cane, metal or plastics, a single flapping reed is constituted, starting from its distal end to its proximal end, of a heel and a table, said table constituting the vibratile portion of the reed. At its most proximal end, the table has an extremely thin thickness, so that it is particularly sensitive to the alteration and clogging due in particular to the contact with the mouthpiece or the handling during the setting-up and the setting of the reed.

The mouthpiece is, in turn, mainly composed of three functional areas, namely a table, a beak and a pipe. The table, or receiving surface of the reed, consists in the association of a flat surface, receiving the heel or a fixed portion of the reed, and a curved surface, drawing the opening of the mouthpiece. Extending in a coplanar manner with the flat face of the table of the mouthpiece, the beak is the surface on which the reed is fastened to the mouthpiece. Finally, the pipe is the meeting of the bore, which extends towards the body of the instrument, and the chamber which extends, in turn, towards the mouth of the musician and which comes out from the mouthpiece under the table of the reed.

The relative position of the reed on the mouthpiece of a musical wind instrument, for example of the clarinet or saxophone type, may greatly influence the sound and the play features of the instrument. Consequently, a very high accuracy of the positioning of the reed on the mouthpiece is sought by the musician. Conventionally, the reed is held in position on the mouthpiece, at the beak, using a member called ligature, a kind of ring or collar which secures the heel of the reed to the mouthpiece while authorizing the vibration of the table of the reed. Such a ligature may be flexible, for example made of leather, or on the contrary substantially rigid, for example made of metal or plastics.

According to this well-known solution, the musician positions the reed on the mouthpiece of his instrument, then comes to clasp it with a ligature. This results in an iterative setting of the respective positions of the reed and the ligature, relative to each other and to the mouthpiece, until obtaining a positioning of the reed allowing obtaining the desired optimal sound result. This procedure of fastening and setting may prove to be relatively laborious, impractical and not very accurate, because the ligature should be systematically adjusted again each time the reed is displaced. In particular, the fine settings of the reed relative to the mouthpiece tip are in particular difficult. Thus, this results in a loss of time, a risk of damage to the table of the reed, for an uncertain result. This issue is stronger as far as it is about beginner musicians or student musicians. Indeed, it is not uncommon for the teacher to devote a part of his teaching time to helping his students to adequately fasten the reed on their instruments.

Solutions have been regularly sought to remedy these drawbacks, but unfortunately, they remain very often very complex to implement, unergonomic in particular for beginner musicians with the limited dexterity, and sometimes even require prior specific preparation of the reed, for example at its heel, or else the use of a reed expressly developed for a use with the corresponding ligature.

### SUMMARY OF THE INVENTION

The invention consequently aims to remedy the different drawbacks previously listed, and to propose a new ligature which, while being in particular simple, practical and ergonomic for use, allows an optimal holding of the reed on the mouthpiece.

Another object of the invention aims to propose a new ligature allowing proceeding to the replacement of a reed in a particularly simple and fast manner.

Another object of the invention aims to propose a new ligature allowing locking/unlocking the reed in position relative to the mouthpiece in a particularly ergonomic manner only requiring the use of a single hand.

Another object of the invention aims to propose a new ligature further allowing a particularly easy, fast and accurate manual setting of the positioning of the reed relative to the mouthpiece of the instrument.

Another object of the invention aims to propose a new ligature which, while allowing a particularly easy, fast and accurate manual setting of the positioning of the reed relative to the mouthpiece of the instrument, may be used with a standard reed, without requiring transforming or adapting the body of the reed.

Another object of the invention aims to propose a new fastening device of a reed on the mouthpiece of the instrument of a musical wind instrument with single flapping reed designed to significantly limit the risk of damaging the reed, in particular by a friction thereof during its setting-up or the setting of the position thereof.

Another object of the invention aims to propose a new attachment method of a single flapping reed to a mouthpiece of a musical instrument, in particular simple, practical and fast to implement, which only requires a minimum number of manual operations.

Another object of the invention finally aims to propose a new attachment method of a single flapping reed to a mouthpiece of a musical instrument allowing a particularly easy, fast and accurate manual setting of the positioning of the reed relative to the mouthpiece of the instrument.

The objects assigned to the invention are reached using an attachment ligature of a single flapping reed to a mouthpiece of a musical instrument, said ligature comprising a main body intended to be secured to said mouthpiece and being characterized in that it further comprises:
a holding member of the reed, movably mounted relative to said main body between a stress position in which the holding member is designed to exert on the reed an immobilization stress of the reed relative to the mouthpiece and at least a release position in which the holding member is designed to release said stress in order to authorize a displacement of the reed relative to the mouthpiece,
a control lever manually actuatable and pivotally mounted relative to the main body between a rest position in which said lever cooperates with the holding member so that said holding member occupies the stress position thereof and at least one actuated position in which said lever stresses the holding member in the release position thereof,

and an elastic return member, which elastically returns said holding member and control lever respectively in the stress position and in the rest position.

The objects assigned to the invention are also reached using an attachment method of a single flapping reed to a mouthpiece of a musical instrument by means of a ligature, said ligature comprising a main body intended to be secured to said mouthpiece, said method being characterized in that said mouthpiece also comprises a holding member of the reed, movably mounted relative to said main body between a stress position, which is an elastic return position in which the holding member is designed to exert on the reed an immobilization stress of the reed relative to the mouthpiece and at least one release position in which the holding member is designed to release said stress in order to authorize a displacement of the reed relative to the mouthpiece, said method comprising the following steps, in chronological order:
(i) securing of the main body to the mouthpiece,
(ii) manually actuating a control lever pivotally mounted relative to said main body to pivot said control lever from a rest position, which is an elastic return position, to an actuated position in which said control lever stresses the holding member in the release position,
(iii) inserting the reed between the mouthpiece and the holding member while said holding member is stressed in the release position,
(iv) ceasing the manual actuation of the control lever, which causes the return of the control lever to the rest position and the holding member to the stress position.

### SUMMARY DESCRIPTION OF THE DRAWINGS

Other objects and advantages of the invention will appear in more detail upon reading the description which follows, as well as using the appended drawings provided for purely explanatory and non-limiting purposes, in which:

FIG. 1 illustrates in side view, and in a highly schematic manner, the general assembly of a single flapping reed on the mouthpiece of a wind instrument, of the clarinet or saxophone type, said reed being held in position by a ligature according to the invention;

FIG. 2 illustrates a top view, a bare single flapping reed;

FIGS. 3 and 4 illustrate, in perspective, a preferred embodiment of the invention, reciprocally in a first release configuration (FIG. 3) in the ligature of the invention is capable of accommodating within it a single flapping reed, and in a second stress configuration (FIG. 4), in which the ligature carries a single flapping reed;

FIG. 5 illustrates, in front view, the preferred embodiment of FIGS. 3 and 4 of the ligature according to the invention, the control lever has been masked in order to allow visualizing of the underlying parts;

FIGS. 6 and 7 illustrate, in perspective, respectively in top (FIG. 6) and in bottom (FIG. 7) views, a preferred embodiment of a certain number of the different elements and subsets of elements ensuring the setting function of the longitudinal position of the reed, relative to the mouthpiece of the instrument (not shown), the ligature according to the invention. In particular, FIGS. 6 and 7 illustrate an embodiment of the setting device that preferably comprises the ligature of the invention;

FIG. 8 illustrates, in rear perspective view, the interaction between the different elements and of subsets of elements shown in FIGS. 6 and 7 with the control lever of the ligature;

FIGS. 9 and 10 also illustrate, respectively in longitudinal section and in cross section, some of the subsystems and members ensuring the setting function of the longitudinal position of the reed, relative to the mouthpiece of the instrument (not shown) in a configuration where a single flapping reed is in place in the ligature of the invention;

FIG. 11 illustrates, in a longitudinal section, more specifically a preferred embodiment of the transmission system of the movement of the setting device of the longitudinal position of the reed. The ligature carries on this figure a single flapping reed and the control lever is in the rest position thereof in which the longitudinal displacement of the reed relative to the mouthpiece of the instrument (not shown) is stressed;

FIGS. 12 and 13 illustrate, respectively in an exploded view (FIG. 12) and in cross-sectional view (FIG. 13), a first preferred embodiment of some of the subsystems and members ensuring the setting function of the longitudinal position of the reed, relative to the mouthpiece of the instrument (not shown), in particular the activation member of the movement transmission system.

FIG. 14 illustrates, in top view, an alternative embodiment of the setting device which comprises the ligature of FIGS. 3 and 4.

FIGS. 15 and 16 illustrate, respectively in sectional view and exploded view, an alternative embodiment of the manual activation member of the movement transmission system.

### BEST MODE FOR CARRYING OUT THE INVENTION

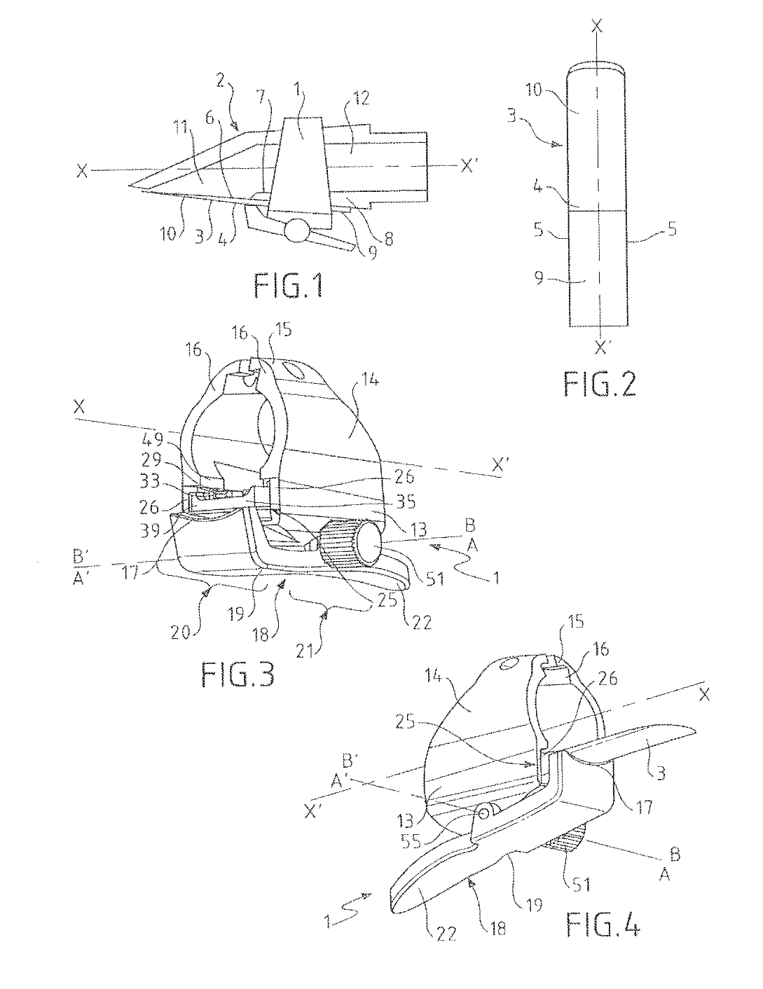

FIG. 1 schematically offers, an overview of the assembly of a ligature 1 according to the invention on the mouthpiece 2 of a wind instrument, of the clarinet or saxophone type, to allow the fastening of a single flapping reed 3 on said mouthpiece 2. In what follows, the directions «top» and «bottom» are defined considering the longitudinal extension direction (rectilinear or curvilinear) of the concerned wind instrument, the top of the instrument corresponding to the mouthpiece while the bottom corresponds to the bell, such that the instrument extends downwardly from the mouthpiece towards the bell, and upwardly from the bell towards the mouthpiece.

Moreover, the reed 3 shown alone in FIG. 2, has an upper face 4, of a slightly domed shape from an edge 5 to the other, and a lower face 6 substantially flat, this lower face 6 being intended to come into contact with the table 7 of the mouthpiece 2. Said reed 3 is held in position on the mouthpiece 2, at the beak 8, using a ligature 1 which secures the heel 9 of the reed 3 to the mouthpiece 2 while authorizing the vibration of the table 10 of the reed 3 opposite to the chamber 11. This vibration of the reed 3 opposite to the chamber 11 of the mouthpiece 2, under the effect of the breath of the user, spearheads the sound of the instrument, which will propagate from the chamber 11 to the body of the instrument through the bore 12 which that said mouthpiece 2 has, said bore 12 extending longitudinally along the bore mean central axis X-X′.

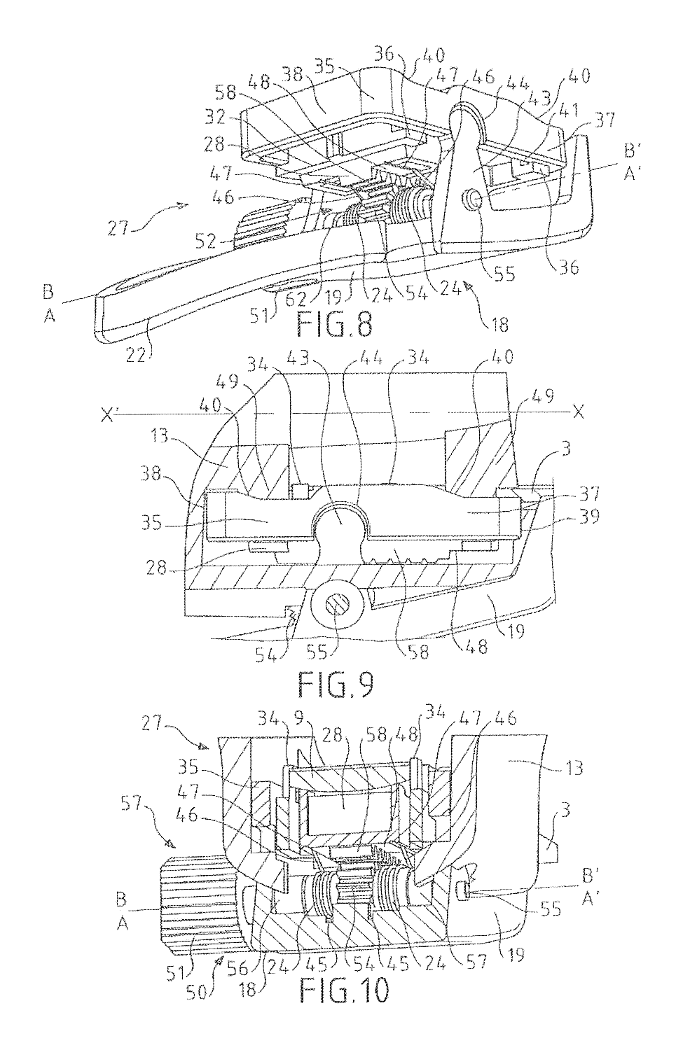

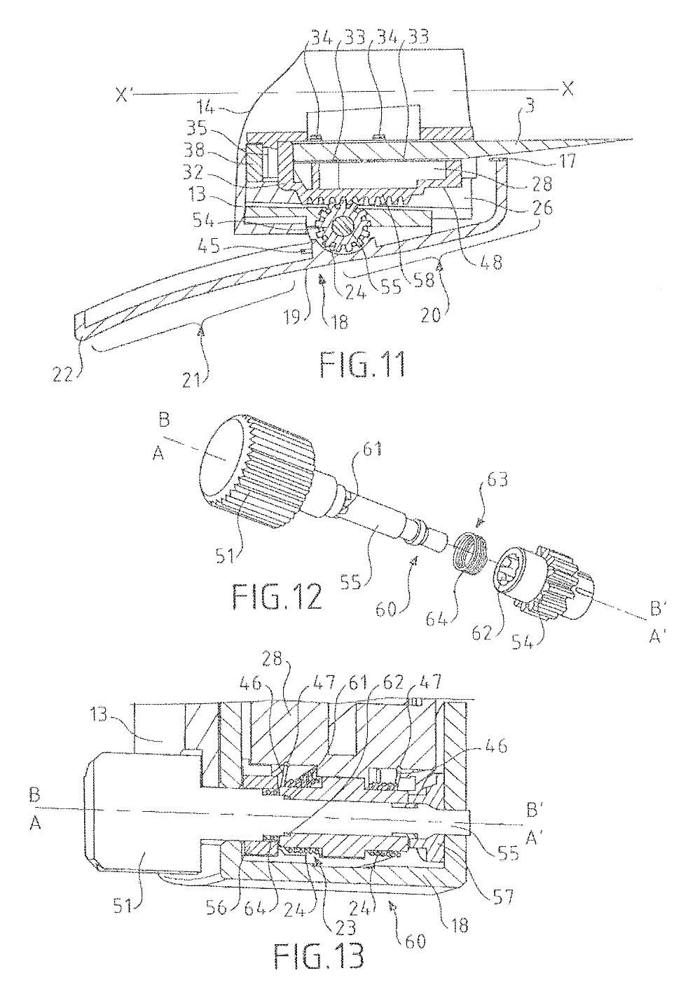

FIGS. 3 to 13 illustrate a preferred embodiment of a ligature 1 in accordance with the invention. The ligature 1 forms a ligature 1 for attaching, for example manually, a single flapping reed 3 to a mouthpiece 2 of a musical instrument, for example a clarinet or saxophone, or an instrument of the family of clarinets or saxophones respectively. However, the invention is not limited to a clarinet or saxophone ligature, and might concern any type of removable single flapping reed wind instrument.

According to the invention, the ligature 1 comprises a main body 13 intended to be secured to the mouthpiece 2 of the instrument. The term «secured means» that the main body 13 is firmly fastened to the mouthpiece 2, on at least one portion of its length, such that it cannot be displaced relative to the mouthpiece 2 once positioned and fastened on said mouthpiece, either by an intentional or unintentional handling of the musician, or simply by the vibrations of the body of the instrument. Preferably, the main body 13 is removably secured to said mouthpiece 2 of the instrument, such that for example the same ligature 1 may be used with different mouthpieces. Alternatively, it is quite possible, without departing from the invention, that the main body 13 is non-removably secured to the mouthpiece 2, that is to say that the main body 13 is permanently fastened to said mouthpiece 2. In order to allow this securing of the main body 13 to the mouthpiece 2 of the instrument, said main body 13 preferably comprises a collar 14 intended to encircle the mouthpiece 2, for example at the beak 8 of said mouthpiece 2, said collar 14 is provided with an attachment member 15 allowing the removable fastening of the collar 14 to the mouthpiece 2.

According to a preferred embodiment of the invention, and as shown in FIGS. 2 to 4, this collar 14 forms an annular shaped fastening means which is preferably integral with the main body 13 so as to form with said main body one-piece part body. However, it is possible to consider that said collar 14 consists, alternatively, of a distinct part of the main body 13, rigid or even flexible, directly attached on said main body 13. Furthermore, and more particularly in an embodiment according to which the collar 14 is rigid, the inner surface of the collar 14 of the ligature 1 may be, advantageously, covered or coated with a specific material capable of absorbing, at least partially, possible parasitic vibrations of the ligature 1. Such a material may also allow facilitating the sliding of the collar 14 relative to the mouthpiece 2 while avoiding the damage, of a scratch or clamping mark type, of the material of the mouthpiece 2 during the setting-up and the clamping of the ligature 1.

Said attachment member 15 comprises at least one clamping screw (not shown) provided with a manually actuatable clamping/unclamping head, for example of the thumbwheel type. In the preferred embodiment illustrated in the figures, this clamping screw advantageously constitutes a complementary means allowing bringing the jaws 16 closer to the collar 14 by screwing/unscrewing. However, it is possible, of course, to imagine an alternative configuration of said fastening member 15, according to which said fastening member 15 would comprise at least one screw, said screw not being a clamping screw, but for example, a set screw.

According to an important feature of the invention, the ligature 1 further comprises a holding member 17 of the reed 3, movably mounted relative to said main body 13, preferably pivotally along a first pivot axis A-A′, between a stress position in which the holding member 17 is designed to exert on the reed 3, for example on the upper face 4 at the heel 9 of said reed 3, an immobilization stress of the reed 3 relative to the mouthpiece 2 and at least one release position in which the holding member 17 is designed to release said stress in order to authorize a displacement of the reed 3 relative to the mouthpiece 2. As particularly shown in FIGS. 3 and 4, the holding member 17 is, for example, in the form of a rectangular bar whose face intended to come into contact with the upper surface 4 of the heel 9 of the reed 3, has a concave shape advantageously complementary to the convex profile of said heel 9 of the reed 3. When said holding member 17 occupies the stress position thereof, thus, it applies a pressure force on the upper face 4 of the reed 3, which causes the plating of said reed 3 on the table 7 of said mouthpiece 2.

The holding member 17 is, further, preferably constituted of a deformable material in compression, both capable of absorbing, at least partially, the possible vibrations of the heel 9 of the reed 3 and of opposing the displacement of the reed 3 relative to the mouthpiece 2, by the single friction force of the holding member surface 17 on the surface 4 of the heel 9 of the reed 3 when said holding member 17 is in the stress position. Suitable materials for producing such a holding member 17 are, for example and without limitation, felt, rubber or more generally a material of the family of elastomers. Preferably, the holding member 17 is distinct and independent of the attachment member 15 previously described. It is thus advantageously possible for the user to act on the fastening and the positioning of the reed 3 relative to the mouthpiece 2 without accidentally modifying the positioning of the ligature 1 itself relative to said mouthpiece 2, and without having to dissociate or unclamp the ligature 1 of the mouthpiece 2.

According to the invention, the ligature 1 further comprises a control lever 18 manually actuatable and pivotally mounted relative to the main body 13, preferably along a second pivot axis B-B′, between a rest position in which said lever 18 cooperates with the holding member 17 so that said holding member occupies the stress position thereof and at least one actuated position in which said lever 18 stresses the holding member 17 in the release position thereof.

Preferably, said ligature being designed so that, when the main body 13 is secured to the mouthpiece 2, said second pivot axis B-B′ extends in a transverse direction substantially perpendicular to the longitudinal direction in which the bore mean central axis X-X′ extends.

Preferably, the first pivot axis A-A′ of the holding member 17 relative to the main body 13, and the second pivot axis B-B′ of the control lever 18 relative to the main body 13 coincide.

As illustrated in particular in FIGS. 3 and 4, this control lever 18 is advantageously is in the shape of an elongated part 19, at the two free ends, which extends longitudinally, between an upper portion 20 which cooperates with the holding member 17 and a lower portion 21, for example spatula-shaped, which forms a handle 22 intended to be manually actuated to control the pivoting of the control lever 18 along the first pivot axis A-A′, said first pivot axis A-A′ passing through a middle portion of said elongated part 19 located between said upper 20 and lower 21 portions. Preferably, the control lever 18 is actuatable by an effort exerted by the hand of the user directly on the handle 22. Said handle 22, shown in particular in FIGS. 3 to 5, is in particular ergonomic to operate by the user and thus allows him to easily maneuver the holding member 17.

The ligature 1 is preferably designed so that, when the main body 13 is secured to the mouthpiece 2, said lower portion 21 is farther from the bore mean central axis X-X′ in the rest position than in the actuated position, the control lever 18 being designed to switch from the rest position thereof to the actuated position thereof in response to a pressure exerted on said lower portion 21, preferably forming said handle 22, in the direction of said bore mean central axis X-X′. Preferably, and as illustrated in the figures, said control lever 18 protrudes from said main body 13, towards the bottom of the instrument when it is handled by the user in the playing position. This spatial configuration of the lever 18 also contributes to make the use of said ligature 1 particularly practical, the user being capable, with the same hand, of holding the body of the instrument and of interacting with the control lever 18. Advantageously, said portion upper 20 of the control lever 18 carries said holding member 17, preferably at its free end. In other words, the holding member 17 is advantageously mechanically connected to the upper portion 20 of the control lever 18.

In the preferred embodiment shown in the figures, said holding member 17 is secured by one of the faces thereof to the end of said upper portion 20 of the control lever 18, the opposite face of the holding member 17 being, in turn, intended to be opposite to the reed 3, such that the holding member 17 and the control lever 18 are part of one and the same unit part.

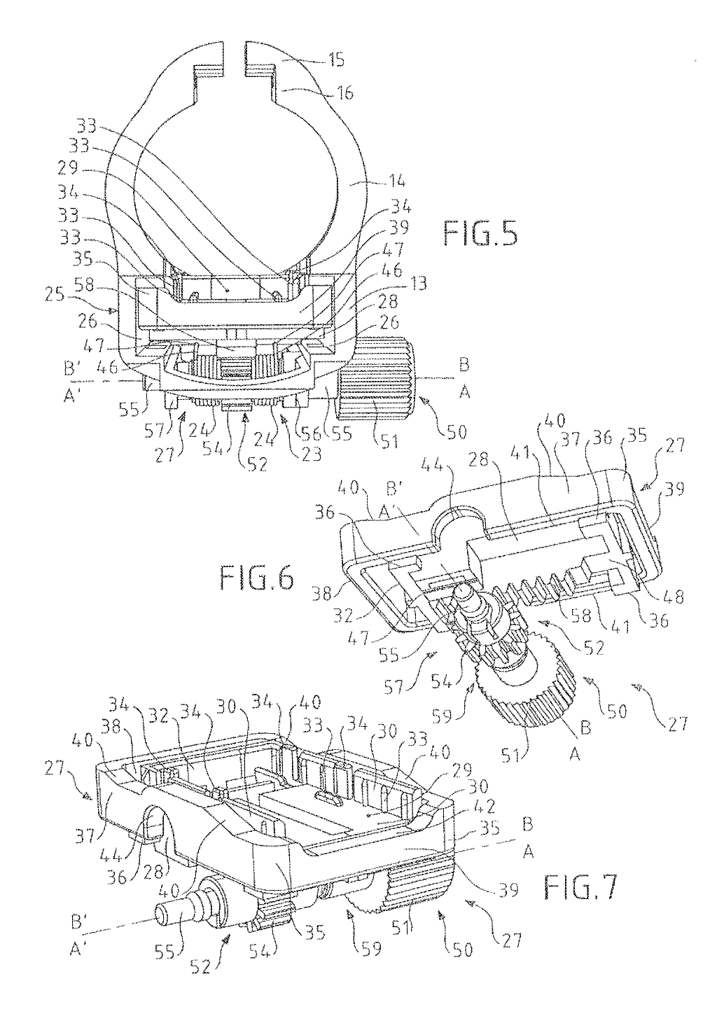

Still according to an important feature of the invention, the ligature 1 further comprises an elastic return member 23, which elastically returns, by design, said holding member 17 and control lever 18 respectively in the stress position and in the rest position. In other words, the elastic return member 23 is designed to elastically return said holding member 17 and control lever 18 respectively to the stress position and to the rest position. Advantageously, and as illustrated in particular in FIG. 5, this elastic return member 23 is preferably positioned at the second pivot axis B-B′ of the control lever 18 relative to the main body 13. This positioning advantageously allows reducing the bulk of the ligature 1 and optimizing the effort that the user should exert on the handle 22 to pivot the control lever 18 from the rest position thereof, in which said lever 18 cooperates with the holding member 17 so that said holding member occupies its stress position of the reed 3, to at least one actuated position, in which said lever 18 stresses the holding member 17 in the release position thereof. In a particularly advantageous manner, said elastic return member 23 is constituted of at least one or two torsion springs 24. This preferred embodiment of the elastic return member 23 and the holding member 17 described above is particularly advantageous in the sense that the plating pressure of the reed 3 on the table 7 of the mouthpiece 2, applied by the holding member 17 through the lever 18, allows automatically compensating any variation in thickness of the reed 3 related, for example to the wear thereof, and thus limiting, or even avoiding, the unwanted air leaks when the user blows into the mouthpiece 2 of the instrument.

Preferably, the ligature 1 comprises a lateral guide device 25 secured to the main body 13 and designed to hold the reed 3 aligned with the mouthpiece 2 while authorizing a longitudinal sliding of the reed 3 along the mouthpiece 2 when the holding member 17 occupies the release position thereof. As illustrated in FIG. 5, the main body 13 is, for this purpose, advantageously shaped to form two cheeks 26 disposed opposite to each other and mutually spaced by a distance greater, and in this case slightly greater, than the width of the reed 3 in order to be able to house said reed in a substantially adjusted manner between said cheeks 26, which are part of said lateral guide device 25. Once the reed 3 is positioned between said cheeks 26 of the main body 13 of the ligature 1, the main body 13 being secured to the mouthpiece 2 of the instrument, the lateral displacement of the reed 3 is thus advantageously stressed, so that only a longitudinal displacement of the reed 3 relative to the mouthpiece 2 is authorized.

As illustrated in FIG. 5, the lateral guide device 25 is integral with the main body 13. Without departing from the scope of the invention, it is of course possible to expect that this lateral guide device 25 constitutes a part or a set of parts distinct from the main body 13 to which it would be secured using dedicated fastening means.

In a particularly advantageous manner, the ligature 1 comprises a setting device 27 designed to adjust, in response to a control handling of a user, the longitudinal positioning of the reed 3 relative to the mouthpiece 2, preferably once the reed 3 placed within the lateral guide device 25. This device is preferably distinct from the fastening system, formed by the collar 14 and the attachment member 15, of the ligature 1 on the mouthpiece 2 of the instrument. This has the major advantage, unlike many existing ligature solutions, of allowing the user to set the longitudinal positioning of the reed 3 relative to the mouthpiece 2 independently not only of the relative positioning of the ligature 1 relative to said mouthpiece 2, but also independently of the lateral positioning of the reed 3, which stresses it by the lateral guide device 25 secured to the main body 13.

As illustrated in FIGS. 6 and 7, the setting device 27 preferably comprises a movable carriage 28 designed to cooperate with the reed 3 so that a displacement of the carriage 28 causes a longitudinal displacement of the reed 3 allowing adjusting the longitudinal positioning of said reed. The use of a movable carriage is however only a preferred possibility, and it might be considered to alternatively resort to any other suitable means, such as for example a setting device 27 comprising a friction roller system in contact with the reed 3.

According to the embodiment illustrated in particular in FIG. 7, said carriage 28 has a lower housing 29 delimited by a lower surface 30, lateral edges 31 and a distal end 32. In this embodiment illustrated in particular in FIG. 7, the lower surface 30 and the lateral edges 31 of the carriage 28 are, moreover, preferably provided with lumps 33, said lateral edges 31 being moreover also provided with spuds 34. The lower housing 29 accordingly defined is, in this manner, capable of receiving and holding the heel 9 of the reed 3 firmly in position, but in removable manner. Said heel 9 is indeed inserted forcefully into said lower housing 29. The lower face 6 of the reed 3 bearing on the spuds 34, the edges 5 of the heel 9 of the reed 3 are sliding along the lateral edges 31 of the carriage 28, until the distal end of the heel 9 of the reed 3 abuts against the distal end 32 of the carriage 28. The lumps 33 of the lateral edges 31 and the lower surface 30 of the carriage 28 oppose the extraction effort of the reed 3, while the lower surface 30 of the reed 3 rests, in the vicinity of the edges 5 of the heel 9 of the reed 3, on the spuds 34.

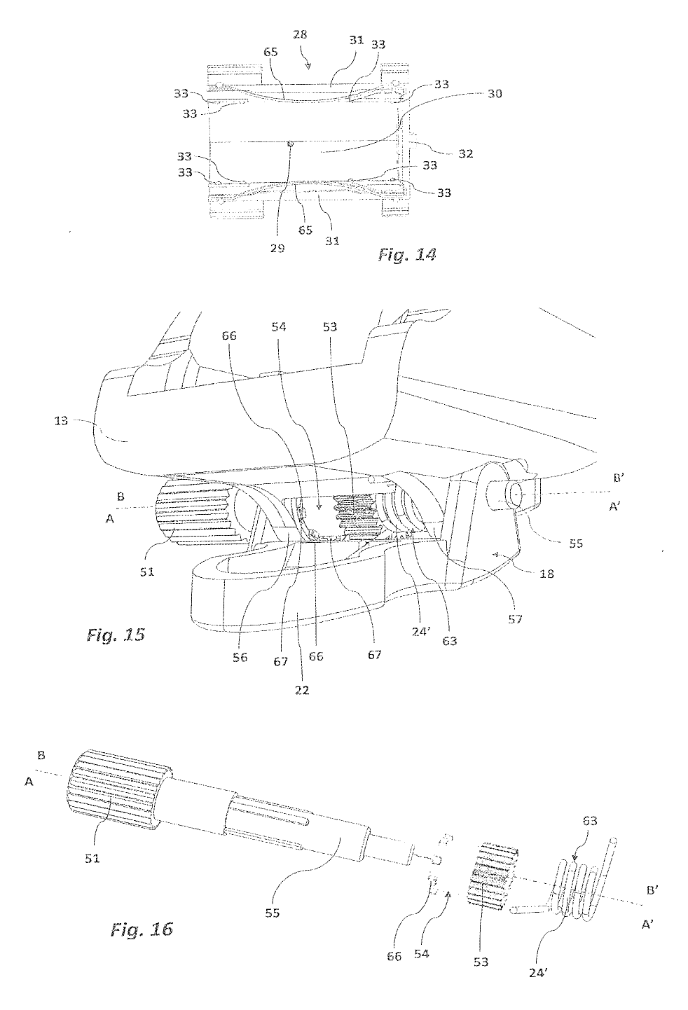

According to another embodiment, illustrated in particular in FIG. 14, the carriage 28 is advantageously provided with lateral blocking means of the reed 3 comprising two curved spring blades 65 disposed in the vicinity of the lateral edges, the convex face of each of these spring blades 65 being turned inwardly of the lower housing 29. These spring blades 65 may be for example distinct parts of the carriage 28, to which they are attached, or on the contrary is integral with said carriage 28 and form with said carriage a single one-piece part. These spring blades 65 allow receiving and holding firmly in position, and in a removable manner, the heel 9 of reeds 3 of different width, by respective simple compression of said blades 65 by the edges 5 of said reed 3.

In addition, said setting device 27 preferably comprises a carriage guide 35, relative to which said movable carriage 28 is slidably mounted. Advantageously housed between the cheeks 26 of the lateral guide device 25, said carriage guide 35 is itself movably mounted relative to said main body 13. According to a preferred embodiment of the invention illustrated in particular in FIGS. 6 and 7, this carriage guide 35 mainly consists of a frame of a rectangular geometry. This frame is defined by lateral walls 37, a distal wall 38 and a proximal wall 39, the base of each of the lateral walls 37 having a profile which locally has at least one slope 40. Said slopes 40 of the respective bases of said lateral walls 37 are symmetrically positioned vis-a-vis to each other. Furthermore, the proximal wall 39 advantageously has a concave clearance 42, in particular shown in FIG. 7, allowing the passage of the upper domed surface 4 of the reed 3 during the insertion thereof within the lower housing 29 of the carriage 28. As illustrated in FIGS. 6 to 8, the mounting of the carriage 28 relative to the carriage guide 35 is, for example, made using sliders 36 being integral with the carriage 28 and which, the carriage 28 being positioned within the carriage guide 35, rest on the edge 41 of the lateral walls 37 of said carriage guide 35 so as to allow the sliding of the movable carriage 28 relative to said carriage guide 35.

Said carriage guide 35 is advantageously mechanically connected to said control lever 18 so that the displacement of said carriage guide 35 is controlled by the manual actuation of said lever 18. In other words, said carriage guide 35 is advantageously movably mounted relative to the main body 13, is mechanically connected to said control lever 18 and is configured so that the displacement of said carriage guide 35 is controlled by the manual actuation of said lever 18. Said carriage guide 35 is thus advantageously designed to fulfill a dual technical function. Indeed, it allows, in a first function, to stress the longitudinal displacement of the carriage 28 relative to the mouthpiece 2. The movable carriage 28, slidably mounted relative to the carriage guide 35, may indeed move only between a position Pₘᵢₙ, in which said carriage 28 abuts against the distal wall 38 of the carriage guide 35, and a position Pₘₐₓ, in which said carriage 28 abuts this time against the proximal wall 39 of the carriage guide 35.

In a particularly preferred manner, the maximum travel of the carriage 28 between the positions Pₘᵢₙ and Pₘₐₓ thereof is substantially equal to 4 mm, which allows providing the user with an optimum setting range of the longitudinal position of the reed 3 relative to the mouthpiece 2 of the instrument.

Still according to a particularly advantageous embodiment illustrated in FIGS. 8 and 9, the control lever 18 includes two extension arms 43 along an axis perpendicular to the general extension plane of said control lever 18, parallel and spaced from each other by a distance equal to the width of the carriage guide 35. Each of these arms 43 is intended to cooperate respectively with a notch 44 formed in the corresponding lateral wall 37 of the carriage guide 35, so that the carriage guide 35 is mechanically connected to said control lever 18, and that the displacement of said carriage guide 35 is thus controlled by the manual actuation of said lever 18.

In a particularly advantageous manner, a first leg 45 of said at least one torsion spring 24 preferably constituting the elastic return member 23 bears under the lower portion 21 of the control lever 18, while its second leg 46 bears in the groove of at least one, preferably two, corresponding longitudinal slots 47 formed in the upper surface 48 of the carriage 28. This configuration is particularly seen in FIGS. 8 to 11.

The cooperation between the carriage 28, the carriage guide 35, the control lever 18 and the main body 13 is thus configured only when the handle 22 of the control lever 18 is actuated and that said control lever pivots relative to the main body 13 of the rest position thereof to at least one actuated position, the arms 43 are capable of causing in the movement thereof, similar to the movement of a balance, a longitudinal displacement of the carriage guide 35 relative to the mouthpiece 2, towards the opening of the mouthpiece 2.

Each of the cheeks 26 of the guide device 25, as described above and illustrated in FIG. 5, moreover preferably includes at least two ramps 49 positioned symmetrically opposite to each other. When the handle 22 of the control lever 18 is actuated and that said control lever pivots relative to the main body 13 from the rest position thereof to at least one actuated position, the arms 43 causing in the movement thereof said longitudinal displacement of the carriage guide 35 relative to the mouthpiece 2, in the direction of the opening of the mouthpiece 2, the slopes 40 of the base of the carriage guide 35 advantageously cooperate with the ramps 49 of the cheeks 26 of the guide device 25, so as to bring the carriage guide 35 to describe, simultaneously to said longitudinal displacement of said carriage guide 35 relative to the mouthpiece 2, an orthogonal translation movement relative to the bore mean central axis X-X′ of the mouthpiece 2. The carriage guide 35, relative to which said movable carriage 28 is slidably mounted, thereby fulfills its second technical function, which consists in allowing the switch of the control lever 18 from its rest position to its activated position causes a spacing of the carriage 28 relative to the bore mean central axis X-X′.

However, the effort exerted on the carriage 28 by said second corresponding leg 46 of the at least one torsion spring 24, holds said carriage 28 in permanent contact with the carriage guide 35 and opposes, because of the single friction force of said second leg 46 in the groove of the at least one longitudinal slot 47 of the carriage 28, to the longitudinal displacement of the carriage 28 relative to the mouthpiece 2 induced by the path of the carriage guide 35. Consequently, while the carriage guide 35 describes, under the effect of the actuation of the handle 22 of the control lever 18, a curvilinear trajectory, the carriage 28 is, in turn, substantially displaced only in an orthogonal translational movement relative to the bore mean central axis X-X′ of the mouthpiece 2. In this manner, the carriage 28 is preferably mechanically connected to the control lever 18 and the ligature 1 is advantageously designed such that when the main body 13 is secured to the mouthpiece 2, the switch of the control lever 18 from its rest position to its activated position causes a spacing of the carriage 28 relative to the bore mean central axis X-X′. In a particularly advantageous manner, the maximum spacing accordingly generated between the reed 3, housed in the carriage 28, and the table 7 of the mouthpiece 2 of the instrument to which the main body 13 of the ligature 1 is secured is substantially equal to 1 mm. This relative spacing, induced by the actuation of the handle 22 of the control lever 18, of the carriage 28 relative to the mouthpiece 2 of the instrument to which the ligature 1 is secured, allows the user, on the one hand, to easily insert the reed 3 into the lower housing 29 of the carriage 28, and, on the other hand, once said reed 3 housed in said lower housing 29, to set the longitudinal positioning of the reed 3 relative to the mouthpiece 2 through the actuation of the setting device 27 without generating a potentially harmful friction of said reed 3 on said mouthpiece 2.

Alternatively, the setting device 27 may comprise a carriage 28 which is, on the contrary, not mechanically connected to the control lever 18, such that the switch of said control lever from its rest position to its activated position does not cause in this case a spacing of the carriage 28 relative to the bore mean central axis X-X′. It will be understood that, in this embodiment, the ligature 1 then preferably does not comprise a carriage guide 35, and the cheeks 26 of the guide device 25 are preferably devoid of ramps.

Advantageously, the holding member 17 is designed to degrade the operation of said setting device 27 when it occupies the stress position thereof, and on the contrary to promote the operation of said setting device 27 when it occupies the release position thereof. The term «degrade» means that the holding member 17 partially, and not completely, opposes the proper operation of said setting device 27. Indeed, if the holding member 17 is designed to degrade the operation of said setting device 27 when it occupies the stress position thereof, for example by the single friction force exerted by the holding member 17 on the reed 3, however, preferably it does not completely inhibit the operation of said setting device 27, such that it is still nevertheless possible for the user to maneuver the setting device 27 even though the holding member 17 occupies the stress position thereof in which said holding member 17 presses on the reed 3 and plate it on the table 7 of the mouthpiece 2. For this purpose, it is sufficient for the user to exert on the setting device 27 a sufficient force to counter the friction force of the upper surface of the holding member 17 on the upper surface of the heel 9 of the reed 3. Consequently, this advantageously allows the user to carry out a particularly fine setting of the longitudinal position of the reed 3 relative to the mouthpiece 2. Conversely, when the holding member 17 occupies the release position thereof, it is advantageously no longer in contact with the reed 3 and, consequently, promotes the operation of the setting device 27. It is of course possible, without departing from the scope of the invention, to consider other means allowing the holding member 17 to degrade, without completely prohibiting, or to promote the operation of the setting device 27. It may for example be considered that the holding member 17 is provided with a cam or a finger which would interfere with the setting device 27 by friction so as to hinder its proper operation, when the holding member 17 occupies the stress position thereof.

Preferably, the setting device 27 comprises a manually actuatable control member 50. This control member 50 is advantageously distinct from the control lever 18, so as to allow a simultaneous handling, in particular practical, of both, a hand of the user acting on the lever 18, while the other hand acts on the control member 50 of the setting device 27. Still more preferably, this control member 50 comprises both a rotary setting thumbwheel 51, and a transformation system 52 of the rotational movement of said thumbwheel 51 into a longitudinal sliding movement of the reed 3 along the mouthpiece 2.

Said movement transformation system 52 preferably comprises a gear sector 53, for example, according to the embodiment shown in particular in FIGS. 5, 6 and 7, a gear wheel 54. This gear sector 53 is mounted in rotation under the monitoring of said setting thumbwheel 51, a portion of said carriage 28 being shaped to be in contact with said gear sector 53 so as to transmit the rotational movement of said setting thumbwheel 51 to said carriage 28. Of course, other designs of such a transformation system of the rotational movement of said thumbwheel 51 into a longitudinal sliding movement of the reed 3 can be perfectly considered, such as pulley systems, of a screw/nut or even rod/crank type, without departing from the scope of the invention.

According to a preferred embodiment of the invention, and as illustrated in FIGS. 6 and 7, the transformation system 52 includes a rod 55 extending the setting thumbwheel 51 along an axis coincident with the axis of rotation of said setting 27 thumbwheel 51, on which the gear wheel 54 is mounted. The rod 55 preferably extends between a first lug 56 and a second lug 57, positioned opposite to each other on the upper portion of the main body 13, and in particular seen in FIG. 5, and opens on both sides of through-orifices formed respectively in each of said lugs 56, 57, such that said rod 55 moreover advantageously constitutes the pivot shaft along the axis A-A′ of the control lever 18 relative to the main body 13.

Furthermore, the movable carriage 28 has, according to the preferred embodiment illustrated in the figures, a shaped portion forming a rack 58 in contact with the gear wheel 54, said rack 58 being advantageously integral with the carriage 28 so as to form with said carriage a single one-piece part.

The setting device 27 preferably comprises a transmission system 59, mounted between the control member 50 and the transformation member 52 and designed to move between:
an activation configuration, in which the transmission system 59 transmits the rotational movement of the setting thumbwheel 51 to the movement transformation system 52;
an inhibition configuration, in which either the transmission system 59 does not transmit the rotational movement of the setting thumbwheel 51 to the movement transformation system 52, or the transmission system 59 prohibits any rotational movement of the thumbwheel 51.

According to the preferred embodiment shown in the figures, said transmission system 59 coincides with the assembly formed by the thumbwheel 51 of the control member 50 and the rod 55 of the transformation system 52.

Preferably, the control member 50 moreover comprises a manual activation member 60 of the transmission system 59, in order to allow the switch of said transmission system 59 from its inhibition configuration to its activation configuration. Thus, the transmission system 59 is preferably inhibited when the activation member 60 is not maneuvered, which allows avoiding any unintentional modification by the musician of the setting of the positioning of the reed 3.

According to a first particularly advantageous embodiment, and as illustrated in FIGS. 12 and 13, the manual activation member 60 of the transmission system 59 is advantageously formed by:
at least one first longitudinal key 61 protruding from the body of the rod 55;
at least one first spline 62 arranged in the hub of the gear wheel 54, said at least one first spline 62 being capable of allowing the gearing of the rod 55 in the gear wheel 54 by its cooperation with said at least one first longitudinal key 61 of the rod 55; on the contrary, the gear wheel 54 being free about the axis of the rod 55 when said at least one first spline 62 of the gear wheel 54 ceases to cooperate with said at least one first longitudinal key 61 of the rod 55.

When maneuvering the activation member 60, the rod 55 meshes with the gear wheel 54 (FIG. 13) so as to allow the transmission of the axial movement of the thumbwheel 51 to the carriage 28. Conversely, when ceasing the maneuvering of the activation member 60, the rod 55 is no longer meshed with the gear wheel 54, and said gear wheel is consequently free relative to the rod 55. The transmission of the axial movement of the thumbwheel 51 to the carriage 28 is then no longer insured.

Furthermore, according to this first embodiment, the activation member 60 may also include a second elastic return member 63, for example a compression spring 64, mounted between the thumbwheel 51 and the main body 13, distinct from the elastic return member 23 of the holding member 17 and the control lever 18, and intended to elastically return the transmission system 59 in the inhibition configuration thereof when the activation member 60 is not maneuvered.

According to the preferred embodiment illustrated in particular in FIG. 13, the actuation of the activation member 60 is obtained by exerting a pressure on the setting thumbwheel 51, according to the axis of rotation of said thumbwheel 51 which coincides with the first pivot axis A-A′, so as to counter the effort of the compression spring 64 and to mesh with the rod 55 in the gear wheel 54.

According to a second embodiment, illustrated in FIGS. 15 and 16, the manual activation member 60 of the transmission system 59 is advantageously formed by:
at least one second longitudinal key 66 protruding radially from the body of the gear wheel 54;
at least one second spline 67 formed in the periphery of the through-orifice of the first lug 56 of the main body 13, and capable of cooperating with said second longitudinal key 66 of the gear wheel 54.

In this second embodiment, the gear wheel 54 is advantageously mounted in a simple translation relative to the rod 55 so as to be capable of sliding axially about the rod 55, for example thanks to a similar key/spline system (FIG. 16).

When the second key 66 of the gear wheel 54 cooperates with the second spline 67 formed in the periphery of the through-orifice of the first lug 56, the activation member 60 holds the transmission system 59 in the inhibition configuration thereof, in which it then prohibits any rotational movement of the thumbwheel 51. On the contrary, when the gear wheel 54 is disengaged from the first lug 56, by sliding along the rod 55, and the second key 66 of the gear wheel 54 no longer cooperates with the second spline 67, the activation member 60 allows the transmission system 59 to occupy the activation configuration thereof, in which it then authorizes the rotational movement of the thumbwheel 51 and the transmission of this movement.

As in the previous embodiment, the activation member 60 may also advantageously include a second elastic return member 63′, preferably mounted between the thumbwheel 51 and the main body 13, intended to elastically return the transmission system 59 to the inhibition configuration thereof when the activation member 60 is not maneuvered.

However, in a particularly advantageous manner and as illustrated in FIGS. 15 and 16, the second elastic return member 63′ may optionally no longer be distinct from the first elastic return member 23 of the holding member 17 and the control lever 18, but on the contrary, be formed by said control lever. Thus, said first elastic return member 23 and second elastic return member 63′ may, for example, be constituted of one and the same spring 24′ designed to work both:
in torsion to ensure the elastic return of the holding member 17 and the control lever 18 respectively to the stress position and the rest position;
in compression/extension, to ensure the elastic return of the transmission system 59 to the inhibition configuration thereof when it is in the activation configuration thereof.

Thus, the actuation of the activation member 60 is consequently obtained by exerting a pressure on the setting thumbwheel 51, according to the axis of rotation of said thumbwheel 51 which coincides with the first pivot axis A-A′, so as to counter the effort of the spring 24′ and to disengage the gear wheel 54 from the first lug 56 of the body 13 by sliding it along the rod 55. The implementation of such a unique spring 24′ thus advantageously allows simplifying the design and the manufacture of the ligature 1, while ensuring a better management of the associated costs.

For the sake of managing costs, ease of manufacture and lightness, and more particularly in a variant of the ligature 1 intended for student musicians and amateur musicians, all or part of the elements constituting the ligature 1 may be made of plastics, since said ligature has a rigidity and a robustness sufficient to allow said elements to properly perform their functions.

It is, however, perfectly possible to consider, in a variant on the contrary intended for experienced musicians and professionals, looking for a ligature combining the features according to the invention, robustness and aesthetics, that all or part of the elements constituting the ligature 1 is manufactured of metal or metal alloy, for example aluminum or titanium, in order to provide them with a better mechanical strength over time. The visible parts, such as for example the control lever 18, the main body 13 and the thumbwheel 51, may also be gilded with fine gold in order to provide them with a refined appearance.

The invention also concerns an attachment method of a single flapping reed 3 to a mouthpiece 2 of a musical instrument by means of a ligature 1, said ligature 1 comprising a main body 13 intended to be secured to said mouthpiece 2, said method being characterized in that said ligature 1 also comprises a holding member 17 of the reed 3, movably mounted relative to said main body 13 between a stress position, which is an elastic return position in which the holding member 17 is designed to exert on the reed 3 an immobilization stress of the reed 3 relative to the mouthpiece 2 and at least one release position in which the holding member 17 is designed to release said stress in order to authorize a displacement of the reed 3 relative to the mouthpiece 2, said method comprising the following steps, in chronological order:
(i) securing the main body 13 to the mouthpiece 2,
(ii) manually actuating a control lever 18 pivotally mounted relative to said main body 13, preferably through a pressure exerted on the handle 22, to pivot said control lever 18 from a rest position, which is an elastic return position, to an actuated position in which said control lever 18 stresses the holding member 17 in the release position,
(iii) inserting the reed 3 between the mouthpiece 2 and the holding member 17, while said holding member is stressed in the release position,
(iv) ceasing the manual actuation of the control lever 18, which causes the return of the control lever 18 in the rest position and the holding member 17 in the stress position.

According to the preferred embodiment shown in the figures, the main body 13 of the ligature 1 is secured to the mouthpiece 2 by the user, the control lever 18 protruding to the bottom of the instrument when said instrument is handled by the user in the playing position, and held firmly fastened thereto via the clamping screw (not shown) of the attachment member 15 of the collar 14.

Using a free finger of the hand holding the instrument, for example with the thumb, the user advantageously presses on the handle 22 in order to actuate the control lever 18, so as to pivot it from its rest position to its actuated position in which said control lever 18 stresses the holding member 17 in the release position and to allow access of the reed 3 to the carriage 28.

The holding member 17 being stressed in the release position, the user, using his free hand, carefully inserts the reed 3 by force between the mouthpiece 2 and the holding member 17, advantageously in the lower housing 29 of the carriage 28, by sliding the edges 5 of the heel 9 of the reed 3 on the spuds 34 and along the lateral edges 31 of the carriage 28, until the distal end of the heel 9 of the reed 3 abuts against the distal end 32 of the carriage 28.

Once the reed 3 firmly positioned within the lower housing 29 of the carriage 28, the user gradually ceases his effort on the handle 22 of the control lever 18, which has the effect of simultaneously causing the return of the control lever 18 towards the rest position thereof, bringing the carriage guide 35 and the carriage 28 closer to the bore mean central axis X-X′ until the lower flat face 6 of the heel 9 of the reed 3 comes into contact with the table 7 of the mouthpiece 2, and the return of the holding member 17 to the stress position.

The implementation method of the ligature 1 further comprises, and in a particularly advantageous manner, a step (v) of adjusting the longitudinal positioning of the reed 3 including the following operations, in chronological order:
manually actuating the control lever 18, preferably through a pressure exerted on the handle 22, to bring said control lever 18 into the actuated position in which said control lever 18 stresses the holding member 17 in the release position,
manually actuating a setting device 27 of the longitudinal positioning of the reed 3 while the control lever 18 is held in the actuated position.

Preferably, the manual actuation operation of the setting device 27 of the longitudinal positioning of the reed 3 comprises the following sub-operations:
actuating the manual activation device 60 of the transmission system 59 from the inhibition configuration thereof, in which either the transmission system 59 does not transmit the rotational movement of the setting thumbwheel 51 to the movement transformation system 52, or the transmission system (59) prohibits any rotational movement of the thumbwheel (51), to the activation configuration thereof, in which the transmission system 59 transmits the rotational movement of the setting thumbwheel 51 to the movement transformation system 52;

According to the preferred embodiment illustrated in the figures, and in particular in FIG. 11, the actuation of the activation member 60 is obtained by exerting a pressure on the setting thumbwheel 51, along the axis of rotation of said thumbwheel 51 which coincides with the first pivot axis A-A′, so as to counter the effort of the compression spring 64 and to mesh the rod 55 with the gear wheel 54.
Then, the activation member 60 being held in the activation position thereof, actuating the rotary setting thumbwheel 51 and the control member 50, by rotating the thumbwheel 51 about the axis thereof in a clockwise or counter-clockwise direction in order to obtain the longitudinal displacement of the desired reed 3 respectively towards the bottom of the instrument or towards the mouthpiece 2.

And, once the optimal setting is obtained:
ceasing the actuation of the activation member 60, by simply releasing the pressure exerted on the thumbwheel 51, in order to return said activation member 60 to the inhibition position thereof;
ceasing the manual actuation of the setting device 27 of the longitudinal positioning of the reed 3;
ceasing the manual actuation of the control lever 18 to bring said control lever 8 in the release position in which said control lever 8 stresses the holding member 7 in the stress position.

It should be noted that, without departing from the scope of the invention, the implementation method of the ligature 1 may comprise the implementation of some of the operations in which the control lever 18 would not be fully actuated, that is to say that the pressure exerted on the handle 22 which preferably forms the lower portion 21 of the lever 18 is not sufficient to bring said handle 22 into contact with the main body 13, or in which the actuation thereof would not be fully ceased, that is to say that the effort exerted on said handle 22 is not fully ceased such that the reed 3 is not perfectly pressed against the table 7 of the mouthpiece 2.

Such an intermediate use of control lever 18 advantageously provides the user with a possibility of particularly fine and accurate setting of the positioning of the reed 3 relative to the mouthpiece 2, by taking advantage of the friction forces being exerted between the upper face 4 of the heel 9 of the reed 3 and the surface of the holding member 17 placed opposite thereto.

### POSSIBILITY OF INDUSTRIAL APPLICATION

The invention finds the industrial application thereof in the design, the manufacture and the use of ligatures for musical wind instruments.

1. A ligature (1) for attaching a single flapping reed (3) to a mouthpiece (2) of a musical instrument, said ligature (1) comprising a main body (13) intended to be secured to said mouthpiece (2) and being characterized in that it further comprises:
a holding member (17) of the reed (3), movably mounted relative to said main body (13) between a stress position in which the holding member (17) is designed to exert on the reed (3) an immobilization stress of the reed (3) relative to the mouthpiece (2) and at least one release position in which the holding member (17) is designed to release said stress in order to authorize a displacement of the reed (3) relative to the mouthpiece (2),
a control lever (18) manually actuatable and pivotally mounted relative to the main body (13) between a rest position in which said lever (18) cooperates with the holding member (17) so that said holding member occupies the stress position thereof and at least one actuated position in which said lever (18) stresses the holding member (17) in the release position thereof,
and an elastic return member (23), which elastically returns said holding member (17) and control lever (18) respectively to the stress position and in the rest position.

2. The ligature (1) according to claim 1, characterized in that said main body (13) comprises a collar (14) intended to encircle the mouthpiece (2), said collar (14) being provided with an attachment member (15) allowing the removable fastening of the collar (14) to the mouthpiece (2).

3. The ligature (1) according to claim 1, characterized in that said attachment member (15) is distinct and independent of the holding member (17).

4. The ligature (1) according to claim 2, characterized in that said attachment member (15) comprises at least one clamping screw provided with a manually actuatable clamping/unclamping head.

5. The ligature (1) according to claim 1, characterized in that it comprises a lateral guide device (25) secured to the main body (13) and designed to hold the reed (3) aligned with the mouthpiece (2) while authorizing a longitudinal sliding of the reed (3) along the mouthpiece (2) when the holding member (17) is in the release position thereof.

6. The ligature (1) according to claim 5, characterized in that the main body (13) is shaped to form two cheeks (26) disposed opposite to each other and mutually spaced by a distance greater than the width of the reed (3) in order to be capable of housing said reed in a substantially adjusted manner between said cheeks (26), which are part of the lateral guide device (25).

7. The ligature (1) according to claim 1, characterized in that said holding member (17) is pivotally mounted relative to the main body (13), and in that said holding member (17) is pivotally mounted relative to the main body (13) along a first pivot axis (A-A′), while said control lever (18) is pivotally mounted relative to the main body (13) along a second pivot axis (B-B′), said first (A-A′) and second (B-B′) pivot axes being coincident.

8. The ligature (1) according to claim 1, characterized in that the holding member (17) and the control lever (18) belong to one single-piece unit part.

9. The ligature (1) according to claim 1, characterized in that said control lever (18) is in the shape of an elongated part (19) extending longitudinally between an upper portion (20) which cooperates with the holding member (17) and a lower portion (21) which forms a handle (22) intended to be manually actuated to control the pivoting of the control lever (18) along a second pivot axis (B-B′), said second pivot axis (B-B′) passing through a middle portion of said elongated part (19) located between said upper (20) and lower (21) portions.

10. The ligature (1) according to claim 9, characterized in that said upper portion (20) carries said holding member (17).

11. The ligature (1) according to claim 9, characterized in that it is designed so that, when the main body (13) is secured to the mouthpiece (2), which has a bore (12) extending longitudinally along a bore mean central axis (X-X′), said lower portion (21) is further away from said bore mean central axis (X-X′) in the rest position than in the actuated position, the control lever (18) being designed to switch from its rest position to its actuated position in response to a pressure exerted on said lower portion (21) in the direction of said bore mean central axis (X-X′).

12. The ligature (1) according to claim 1, characterized in that the control lever (18) protrudes downwardly from said main body (13).

13. The ligature (1) according to claim 1, characterized in that the control lever (18) is pivotally mounted relative to the main body (13) along a second pivot axis (B-B′), said ligature (1) being designed so that, when the main body (13) is secured to the mouthpiece (2), which has a bore (12) extending longitudinally along a bore mean central axis (X-X′), said second pivot axis (B-B′) extends along a transverse direction substantially perpendicular to the longitudinal direction in which said bore mean central axis (X-X′) extends.

14. The ligature (1) according to claim 1, characterized in that it comprises a setting device (27) designed to adjust, in response to a control handling of a user, the longitudinal positioning of the reed (3) relative to the mouthpiece (2).

15. The ligature (1) according to claim 14, characterized in that the holding member (17) is designed to degrade the operation of said setting device (27) when it occupies the stress position thereof, and on the contrary to promote the operation of said setting device (27) when it is in the release position thereof.

16. The ligature (1) according to claim 14, characterized in that said setting device (27) comprises a movable carriage (28) designed to cooperate with the reed (3) so that a displacement of the carriage (28) causes a longitudinal displacement of the reed (3) allowing adjusting the longitudinal positioning of the said reed.

17. The ligature (1) according to claim 16, characterized in that the carriage (28) is mechanically connected to the control lever (18), said ligature (1) being designed so that, when the main body (13) is secured to the mouthpiece (2), which has a bore (12) extending longitudinally along a bore mean central axis (X-X′), the switch of the control lever (18) from its rest position to its activated position causes a spacing of the carriage (28) relative to the bore mean central axis (X-X′).

18. The ligature (1) according to claim 17, characterized in that said setting device (27) further comprises a carriage guide (35), relative to which said movable carriage (28) is slidably mounted, said carriage guide (35) being itself movably mounted relative to said main body (13) and mechanically connected to said control lever (18), so that the displacement of said carriage guide (35) is controlled by the manual actuation of said lever (18).

19. The ligature (1) according to claim 14 characterized in that said setting device (27) comprises a manually actuatable control member (50).

20. The ligature (1) according to claim 19, characterized in that said control member (50) comprises a rotary setting thumbwheel (51), as well as a system (52) for transforming the rotational movement of said thumbwheel (51) into a longitudinal sliding movement of the reed (3) along the mouthpiece (2).

21. The ligature (1) according to claim 20, characterized in that the setting device (27) comprises a transmission system (59), mounted between the control member (50) and the transformation member (52) and designed to move between:
an activation configuration, in which the transmission system (59) transmits the rotational movement of the setting thumbwheel (51) to the movement transformation system (52);
an inhibition configuration, in which either the transmission system (59) does not transmit the rotational movement of the setting thumbwheel (51) to the movement transformation system (52), or the transmission system (59) prohibits any rotational movement of the thumbwheel (51).

22. The ligature (1) according to claim 21, characterized in that said control member (50) comprises a manual activation member (60) of the transmission system (59), in order to allow the switch of said transmission system (59) from its inhibition configuration to its activation configuration.

23. The ligature (1) according to claim 16, characterized in that said movement transformation system (52) comprises a toothed sector (53) rotatably mounted under the monitoring of said setting thumbwheel (51), a portion of said carriage (28) being shaped to be in contact with said toothed sector (53) so as to transmit the rotational movement of the setting thumbwheel (51) to said carriage (28).

24. An attachment method of a single flapping reed (3) to a mouthpiece (2) of a musical instrument by means of a ligature, said ligature (1) comprising a main body (13) intended to be secured to said mouthpiece (2), said method being characterized in that said ligature (1) also comprises a holding member (17) of the reed (3), movably mounted relative to said main body (13) between a stress position, which is an elastic return position in which the holding member (17) is designed to exert on the reed (3) an immobilization stress of the reed (3) relative to the mouthpiece (2) and at least one release position in which the holding member (17) is designed to release said stress in order to authorize a displacement of the reed (3) relative to the mouthpiece (2), said method comprising the following steps, by chronological order :
(i) securing the main body (13) to the mouthpiece (2),
(ii) manually actuating a control lever (18) pivotally mounted relative to said main body (13) to pivot said control lever (18) from a rest position, which is an elastic return position, to an actuated position in which said control lever (18) stresses the holding member (17) in the release position,
(iii) inserting the reed (3) between the mouthpiece (2) and the holding member (17) while said holding member is stressed in the release position,
(iv) ceasing the manual actuation of the control lever (18), which causes the return of the control lever (18) to the rest position and the holding member (17) to the stress position.

25. The method according to claim 24 characterized in that it comprises a step (v) of adjusting the longitudinal positioning of the reed (3) including the following operations, in chronological order:
manually actuating the control lever (18) to bring said control lever (18) into the actuated position in which said control lever (18) stresses the holding member (17) in the release position,
manually actuating a setting device (27) of the longitudinal positioning of the reed (3) while the control lever (18) is held in the actuated position.
